(19) United States
(12) Patent Application Publication
(10) Pub. No.: US 2025/0225768 A1
(43) Pub. Date: Jul. 10, 2025

(54) INFORMATION PROCESSING APPARATUS, SYSTEM, METHOD, AND NON-TRANSITORY COMPUTER-READABLE MEDIUM

(71) Applicant: NEC Corporation, Minato-ku, Tokyo (JP)

(72) Inventor: Yuta Shimizu, Tokyo (JP)

(73) Assignee: NEC Corporation, Minato-ku, Tokyo (JP)

(21) Appl. No.: 18/852,667

(22) PCT Filed: Apr. 22, 2022
(86) PCT No.: PCT/JP2022/018576

§ 371 Date: Sep. 30, 2024

(51) Int. Cl. G06V 10/764; G06V 20/58; G06V 20/70

(52) U.S. Cl. CPC G06V 10/764; G06V 20/58; G06V 20/70

(57) ABSTRACT

A class detection means analyzes a captured image captured by using a camera, and classifies objects included in the captured image into a plurality of classes. A candidate extraction means extracts comparison target image candidates from an information accumulation unit based on imaging information of the captured image. An image selection means selects a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

### TECHNICAL FIELD

The present disclosure relates to an information processing apparatus, a system, a method, and a computer-readable medium.

### BACKGROUND ART

As a related art, Patent Literature 1 discloses an information processing apparatus that specifies a position of a vehicle with high accuracy. The information processing apparatus described in Patent Literature 1 receives a captured image for position specification captured using an imaging device from an in-vehicle apparatus. The information processing apparatus detects a landmark from the captured image for position specification, and extracts landmark information from the captured image for position specification. The landmark information includes a shape, a color, and a pattern of the landmark, and a pattern, and a coordinate range of the landmark on the image.

The information processing apparatus stores positional information, a combination of a plurality of landmarks, and individual landmark information for captured images for registration captured in advance. The information processing apparatus compares the landmark included in the captured image for position specification with the landmark included in the captured image for position registration. The information processing apparatus specifies a captured image for registration in which the landmark matches with that of the captured image for position specification, and specifies the position where the captured image for registration was captured as a position of the vehicle at the time when the captured image for position specification was captured.

### CITATION LIST

### Patent Literature

Patent Literature 1: Japanese Unexamined Patent Application Publication No. 2019-78700

### SUMMARY OF INVENTION

### Technical Problem

As a system for detecting an abnormality using an image of a camera for a vehicle, there may be considered a system that compares two images captured at the same position and at different times and detects a difference to detect a damaged sign or a sign hidden by vegetation or the like. In such a system, it may be considered important to accurately specify an image captured at a different time from an image captured at a certain time at the same position.

In Patent Literature 1, the information processing apparatus specifies a position where the image for position specification was captured, using landmarks such as a sign, a building, and a signboard as clues. By comparing the captured image for position specification with the captured image for registration captured at the same position, it is possible to detect a change that has occurred until the captured image for position specification is captured since the captured image for registration was captured. However, in Patent Literature 1, the weather, the season, and the time at the time of capturing the image are not considered. In Patent Literature 1, in a case where the weather or the time zone in which the image for position specification was captured is different from the weather or the time zone in which the captured image for registration was captured, there is a possibility that a change cannot be correctly detected due to a change in appearance between the images.

In view of the aforementioned circumstances, an object of the present disclosure is to provide an information processing apparatus, a system, a method, and a computer-readable medium capable of selecting an appropriate image as a comparison target image with respect to a captured image.

### Solution to Problem

To achieve the above-described object, the present disclosure provides an information processing apparatus as a first aspect. The information processing apparatus includes: a class detection means for analyzing a captured image captured by using a camera mounted on a mobile object, and classifying objects included in the captured image into a plurality of classes; a candidate extraction means for extracting comparison target image candidates for comparison with the captured image from an information accumulation unit based on imaging information of the captured image, the information accumulation unit being configured to store one or more past images captured in the past, and imaging information including at least one of imaging date and time information and weather information at an imaging time for each of the one or more past images; and an image selection means for selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

The present disclosure provides an information processing system as a second aspect. An information processing system includes: one or more cameras mounted on a mobile object; and an information processing apparatus configured to perform image processing on a captured image captured by using the one or more cameras. The information processing apparatus includes: a class detection means for analyzing the captured image, and classifying objects included in the captured image into a plurality of classes; a candidate extraction means for extracting comparison target image candidates for comparison with the captured image from an information accumulation unit based on imaging information of the captured image, the information accumulation unit being configured to store one or more past images captured in the past, and imaging information including at least one of imaging date and time information and weather information at an imaging time for each of the one or more past images; and an image selection means for selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

The present disclosure provides an information processing method as a third aspect. The information processing method includes: analyzing a captured image captured by using a camera mounted on a mobile object, and classifying objects included in the captured image into a plurality of classes; extracting comparison target image candidates for comparison with the captured image from an information accumulation unit based on imaging information of the captured image, the information accumulation unit being configured to store one or more past images captured in the past, and imaging information including at least one of imaging date and time information and weather information at an imaging time for each of the one or more past images; and selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

The present disclosure provides a computer-readable medium as a fourth aspect. A computer-readable medium stores a program for causing a computer to execute: analyzing a captured image captured by using a camera mounted on a mobile object, and classifying objects included in the captured image into a plurality of classes; extracting comparison target image candidates for comparison with the captured image from an information accumulation unit based on imaging information of the captured image, the information accumulation unit being configured to store one or more past images captured in the past, and imaging information including at least one of imaging date and time information and weather information at an imaging time for each of the one or more past images; and selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

### Advantageous Effects of Invention

The information processing apparatus, the system, the method, and the computer-readable medium according to the present disclosure are capable of selecting an appropriate image as a comparison target image with respect to a captured image.

### BRIEF DESCRIPTION OF DRAWINGS

FIG. 1 is a block diagram illustrating an information processing system according to the present disclosure.

FIG. 2 is a block diagram illustrating an information processing system according to a first example embodiment of the present disclosure.

FIG. 3 is a schematic diagram illustrating an example of a captured image captured by a camera.

FIG. 4 is a schematic diagram illustrating an example in which a comparison target image is selected.

FIG. 5 is a flowchart illustrating an operation procedure in an information processing apparatus.

FIG. 6 is a block diagram illustrating an information processing system according to a second example embodiment of the present disclosure.

FIG. 7 is a block diagram illustrating a hardware configuration of an information processing apparatus.

### EXAMPLE EMBODIMENT

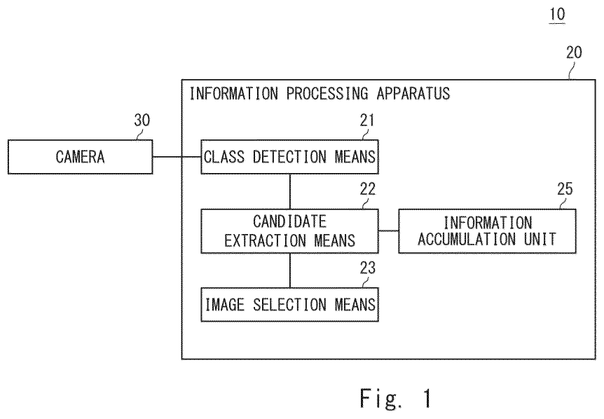

Prior to describing example embodiments according to the present disclosure, an outline of the present disclosure will be described. FIG. 1 illustrates an information processing system according to the present disclosure. An information processing system 10 includes an information processing apparatus 20 and one or more cameras 30. The camera 30 is mounted on a mobile object. The information processing apparatus 20 performs image processing on a captured image captured by using the camera 30.

The information processing apparatus 20 includes a class detection means 21, a candidate extraction means 22, and an image selection means 23. The class detection means 21 analyzes the captured image of the camera 30, and classifies objects included in the captured image into a plurality of classes.

The information accumulation unit 25 stores one or more past images captured in the past and imaging information for each of the past images. The imaging information includes at least one of imaging date and time information and weather information at an imaging time. The candidate extraction means 22 extracts comparison target image candidates for comparison with the captured image from the information accumulation unit 25 based on the imaging information of the captured image.

The image selection means 23 selects a comparison target image from among the comparison target image candidates based on at least one of types of the classes included in the captured image, sizes of regions of the respective classes, and proportions of the regions of the respective classes with respect to the entire image, and those for the respective comparison target image candidates.

In the present disclosure, the candidate extraction means 22 extracts comparison target image candidates from the information accumulation unit 25 based on the imaging information of the captured image. The image selection means 23 selects a comparison target image from among the comparison target image candidates by using classification results. Images captured at the same point are considered to have the same classification result. Therefore, it is considered that an image captured at the same point as the captured image can be selected as a comparison target image by selecting the comparison target image using a classification result. According to the present disclosure, by extracting past images of which imaging information is similar to the imaging information of the captured image as comparison target image candidates, an image suitable for comparison with the captured image can be selected as a comparison target image. Furthermore, by comparing the comparison target image selected in this manner with the captured image, it is possible to find a difference between the two images regardless of a difference in appearance between the images.

Hereinafter, the example embodiments of the present disclosure will be described in detail with reference to the drawings. Note that, in the following description and drawings, omission and simplification are made as appropriate, for clarity of explanation. Furthermore, in the following drawings, the same elements and similar elements will be denoted by the same reference signs, and redundant description will be omitted as necessary.

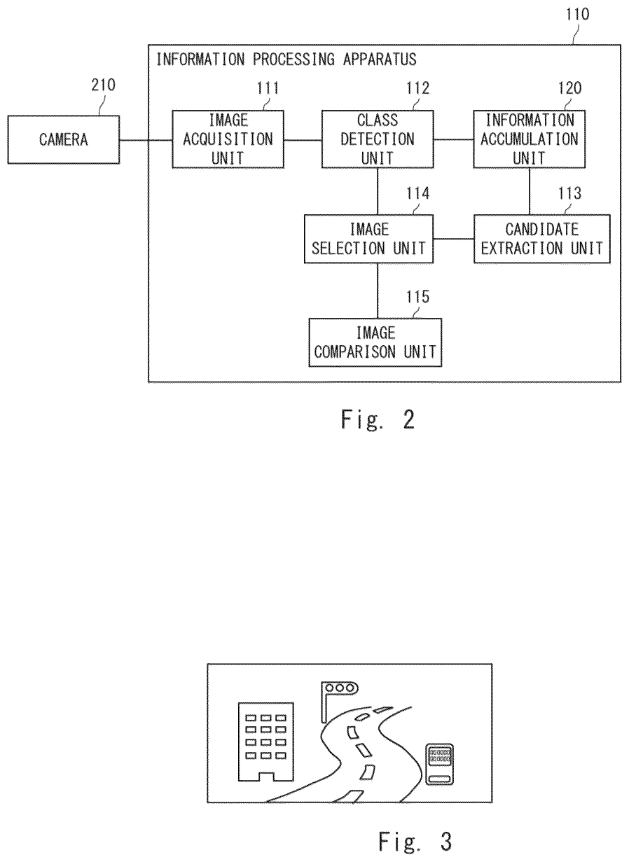

FIG. 2 illustrates an information processing system according to a first example embodiment of the present disclosure. An information processing system 100 includes an information processing apparatus 110 and a camera 210. In the present example embodiment, it is assumed that the information processing apparatus 110 and the camera 210 are mounted on a mobile object. The mobile object includes, for example, a land vehicle such as an automobile, a two-wheeled vehicle, a bus, a taxi, or a truck. The mobile object may be a train, a ship, or an aircraft, or may be a mobile robot such as an automated guided vehicle (AGV).

The camera 210 captures, for example, an image in a traveling direction of the mobile object. The mobile object may include a plurality of cameras 210 having different imaging directions. The information processing apparatus 110 acquires an image captured by using the camera 210, and performs image processing on the acquired image. The information processing system 100 corresponds to the information processing system 10 illustrated in FIG. 1. The information processing apparatus 110 corresponds to the information processing apparatus 20 illustrated in FIG. 1. The camera 210 corresponds to the camera 30 illustrated in FIG. 1.

The information processing apparatus 110 includes an image acquisition unit 111, a class detection unit 112, a candidate extraction unit 113, an image selection unit 114, an image comparison unit 115, and an information accumulation unit 120. The information processing apparatus 110 includes, for example, one or more memories and one or more processors. At least some of the functions of the respective units in the information processing apparatus 110 can be implemented by a processor operating according to a program read from a memory.

The image acquisition unit 111 acquires a captured image from the camera 210. The image acquisition unit 111 acquires captured images from the camera 210 at predetermined time intervals of, for example, 1 second or 10 seconds. The class detection unit 112 analyzes the captured image, and classifies one or more objects included in the captured image into a plurality of classes. The objects include, for example, non-moving objects such as buildings, bridges, traffic lights, vending machines, and signs. For example, the class detection unit 112 divides the captured image into a plurality of segments, and determines what class each of the segments belongs to for each of the segments. Instead of or in addition to the segmentation, the class detection unit 112 may detect an object from the captured image and classify a region where the object is detected into a class corresponding to the object. The class detection unit 112 corresponds to the class detection means 21 illustrated in FIG. 1.

The information accumulation unit 120 stores the captured image captured by the camera 210. The captured image stored in the information accumulation unit 120 is an image captured in the past, and is also called a past image. In addition, the information accumulation unit 120 stores imaging information of the captured image that is a past image. The imaging information includes at least one of imaging date and time information and weather information at an imaging time. Further, the information accumulation unit 120 may store a classification result of the class detection unit 112. The classification result includes, for example, at least one of types of the classes included in the captured image, sizes of regions of the respective classes, and proportions of the regions of the respective classes with respect to the entire image.

For example, the class detection unit 112 stores a captured image, an imaging position, and a classification result in the information accumulation unit 120. For example, the class detection unit 112 may store at least one of types of the classified classes, sizes of regions of the respective classes, and proportions of the regions of the respective classes with respect to the entire image, as a classification result, in the information accumulation unit 120. In addition, the class detection unit 112 stores information regarding date and time and weather, as imaging information, in the information accumulation unit 120. The weather at the imaging position may be acquired from an external server that is not illustrated in FIG. 2, or may be acquired by analyzing the captured image.

Note that the information accumulation unit 120 is not necessarily included in the information processing apparatus 110. The information accumulation unit 120 may be an external storage device, or may be a cloud storage connected to the information processing apparatus 110 via a network. The information accumulation unit 120 corresponds to the information accumulation unit 25 illustrated in FIG. 1.

The candidate extraction unit 113 extracts comparison target image candidates from the information accumulation unit 120 based on the imaging information of the captured image. For example, the candidate extraction unit 113 extracts one or more past images of which imaging information is similar to the imaging information of the captured image as comparison target image candidates. Here, the fact that the captured image and the past images have similar imaging information may mean that, for example, the images are captured in the same season, in the same time zone, or in the same weather. For example, the candidate extraction unit 113 may calculate similarity degrees for each of the season, the time zone, and the weather between the captured image and the past images, and extract a past image having a similarity degree higher than or equal to a predetermined value as a comparison target image candidate.

The candidate extraction unit 113 may extract one or more past images of which the imaging information is similar to the imaging information of the captured image and the imaging position information is similar to the imaging position information of the captured image as comparison target image candidates. Here, the fact that the captured image and the past images have similar imaging positions may mean that the distance between the imaging positions of the images is within a predetermined distance. For example, the candidate extraction unit 113 acquires position information of the mobile object at a time when the captured image is captured as the imaging position of the captured image. The position information is acquired using, for example, a global navigation satellite system (GNSS). The candidate extraction unit 113 extracts, from among the past images stored in the information accumulation unit 120, one or more past images captured at a position close to the imaging position of the captured image and having imaging information similar to that of the captured image as comparison target image candidates. In this case, the candidate extraction unit 113 can extract, for example, a past image considered to have been captured at the same position as the captured image under similar imaging conditions, as a comparison target image candidate. The candidate extraction unit 113 corresponds to the candidate extraction means 22 illustrated in FIG. 1.

The image selection unit 114 selects a comparison target image to be compared with the captured image from among the comparison target image candidates extracted by the candidate extraction unit 113. In the selection of the comparison target image, the image selection unit 114 compares a classification result for the captured image with a classification result for each of the comparison target image candidates. For example, for each of the comparison target image candidates, the image selection unit 114 acquires at least one of types of the classes, sizes of regions of the respective classes, and the regions of the respective classes, as a classification result, from the information accumulation unit 120. The image selection unit 114 selects a comparison target image from among the comparison target image candidates based on a result of comparing the classification results. For example, the image selection unit 114 selects, as the comparison target image, a past image for which a classification result is most similar to the classification result for the captured image. In a case where there are a plurality of images having the same classification result, the image selection unit 114 may select the most recent image as a comparison target image. Alternatively, the image selection unit 114 may select a predetermined number of images from the most recent image as comparison target images.

For example, the image selection unit 114 compares types of classes included in the captured image with types of classes included in each of the comparison target image candidates. The image selection unit 114 determines whether the same classes are detected between the captured image and each of the comparison target image candidates. The image selection unit 114 may exclude a class such as a vehicle that varies as to whether it is detected due to a factor other than the environment from the determination. For example, the image selection unit 114 selects an image having the highest similarity degree or matching degree with respect to the detected classes, from among the comparison target image candidates, as the comparison target image.

The image selection unit 114 may compare the sizes of the regions of the respective classes in the captured image with sizes of respective regions of classes in each of the comparison target image candidates. In this case, the image selection unit 114 may determine whether the same classes are detected, and whether the sizes of the regions of the respective classes match between the captured image and each of the comparison target image candidates. For example, the image selection unit 114 may select, from among the comparison target image candidates, an image in which the same classes as the classes detected in the captured image are detected, and the regions of the respective classes match with those in the captured image in the highest degree, as the comparison target image.

Instead of or in addition to the comparison of the sizes of the regions of the respective classes, the image selection unit 114 may compare the proportions of the regions of the respective classes with respect to the entire image in the captured image with proportions of the regions of the respective classes with respect to the entire image in each of the comparison target image candidates. In this case, the image selection unit 114 may select, as the comparison target image, an image in which the same classes as the classes detected in the captured image are detected, and the proportions of the regions of the respective classes with respect to the entire image are most similar to those in the captured image. The image selection unit 114 corresponds to the image selection means 23 illustrated in FIG. 1.

The image comparison unit 115 compares the captured image acquired by the image acquisition unit 111 with the comparison target image selected by the image selection unit 114. The image comparison unit 115 calculates, for example, a difference between the captured image and the comparison target image. For example, the image comparison unit 115 may calculate a difference between the captured image and the comparison target image for each of the regions of the respective classes. The image selected by the image selection unit 114 is an image captured at the same position as the captured image at a different date and time from the captured image. By calculating a difference for each of the classes, the image comparison unit 115 can detect a change in shape of the class as a final difference. For example, in a case where a traffic light is broken, the image comparison unit 115 can detect the broken traffic light as an abnormality. The image comparison unit 115 may display the captured image and the comparison target image on a display screen in a comparable manner, so that the user compares the images. The image comparison unit 115 may also be referred to as an image comparison means.

FIG. 3 illustrates an example of a captured image captured by the camera 210. In this example, the captured image includes, as objects classified into classes, a road on which the mobile object travels, a building next to the road, and a vending machine. The class detection unit 112 classifies the objects included in the captured image into a road class, a building class, and a vending machine class. The class detection unit 112 outputs a class type, an object position, and a size as a classification result for each of the classes.

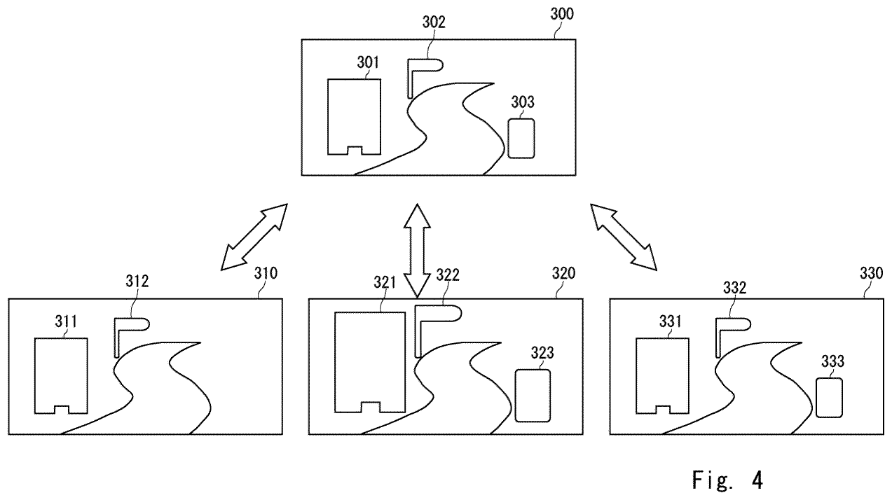

FIG. 4 illustrates an example in which a comparison target image is selected. In this example, it is assumed that three past images are extracted as comparison target image candidates. In FIG. 4, it is assumed that a classification result 300 is a classification result for the captured image illustrated in FIG. 3. The classification result 300 includes one building class 301, one traffic light class 302, and one vending machine class 303 as types of classes.

It is illustrated in FIG. 4. It is assumed that classification results 310 to 330 are results of classification for the respective comparison target image candidates. The classification result 300 includes one building class 311 and one traffic light class 312 as types of classes. The classification result 300 includes one building class 321, one traffic light class 322, and one vending machine class 323 as types of classes. The classification result 330 includes one building class 331, one traffic light class 332, and one vending machine class 333 as types of classes.

The image selection unit 114 compares the classification result 300 with each of the classification results 310 to 330. When the classification result 300 is compared with the classification result 310, types of classes included therein are different. In addition, when the classification result 300 is compared with the classification result 320, the types of classes are the same, but the sizes of the regions of the respective classes are different. When the classification result 300 is compared with the classification result 330, the types of classes are the same, and the sizes of the regions of the respective classes are substantially the same. In this case, the image selection unit 114 selects a past image from which the classification result 330 is obtained, from among the comparison target image candidates, as the comparison target image.

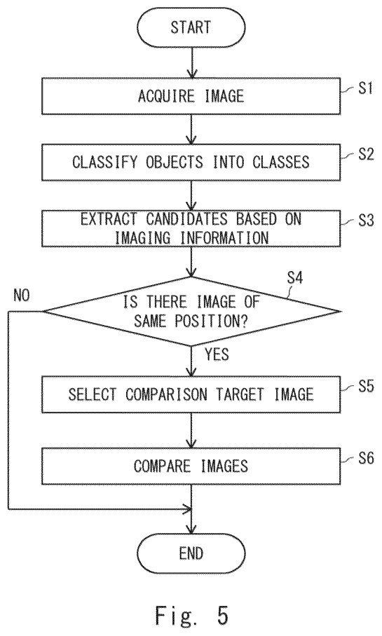

Next, an operation procedure will be described. FIG. 5 illustrates an operation procedure in the information processing apparatus. The operation procedure in the information processing apparatus corresponds to an information processing method. The image acquisition unit 111 acquires a captured image from the camera 210 (step S1). The class detection unit 112 classifies objects included in the captured image acquired in step S1 into a plurality of classes (step S2). The candidate extraction unit 113 extracts comparison target image candidates from the information accumulation unit 120 based on imaging information of the captured image (step S3). In step S3, the candidate extraction unit 113 extracts, for example, one or more past images having imaging information matching with the imaging information of the captured image and captured at positions close to the position considered to be where the captured image is captured, as comparison target image candidates.

The image selection unit 114 determines whether the comparison target image candidates extracted in step S3 include a past image captured at the same position as the captured image (step S4). In step S4, the image selection unit 114 determines whether the comparison target image candidates include a past image captured at the same position as the captured image, based on a classification result for the captured image and a classification result for each of the comparison target image candidates. When there is a past image for which the classification result matches or is similar to the classification result of the captured image, the image selection unit 114 determines that the comparison target image candidates include a past image captured at the same position as the captured image.

When it is determined that the comparison target image candidates include a past image captured at the same position as the captured image, the image selection unit 114 selects the past image as the comparison target image (step S5). The image comparison unit 115 compares the captured image acquired in step S1 with the comparison target image selected in step S6 (step S6). For example, the image comparison unit 115 calculates a difference between the captured image and the comparison target image for each class, and detects whether there is a change in shape for each of the classes.

When there is no past image for which the classification result is the same as or similar to the classification result of the captured image, the image selection unit 114 determines that the comparison target image candidates do not include a past image captured at the same position as the captured image. In this case, the images are not compared. The captured image acquired in step S1 and the result of the classification performed in step S2 are stored as a past image and a classification result for the past image, together with imaging information and imaging position information, in the information accumulation unit 120.

In the present example embodiment, the candidate extraction unit 113 extracts comparison target image candidates from among the past images stored in the information accumulation unit 120 in consideration of the imaging date and time and the weather at the imaging time. The image selection unit 114 selects a comparison target image from among the comparison target image candidates. For example, the image selection unit 114 selects, as the comparison target image, a past image captured under the same conditions as the captured image at a point that is the same as the location where the captured image was captured. By doing so, the image selection unit 114 can select an image that is easy to calculate a difference in time series in the image comparison unit 115, that is, an image suitable for detecting an abnormality, as the comparison target image.

In the present example embodiment, the image selection unit 114 selects a comparison target image from among the comparison target image candidates by using classification results. If a comparison target image is selected based on the traveling speed of the mobile object or the position information of the GNSS, which includes a measurement error, there is a possibility that a discrepancy occurs between the imaging position of the captured image and the imaging position of the selected comparison target image. If the imaging position of the captured image is different from the imaging position of the selected comparison target image, in a use case where it is desired to detect a damaged sign or the like, there is a possibility that an abnormality cannot be correctly detected due to the discrepancy in imaging position. In the present example embodiment, since the comparison target image is selected using the classification results, the past image captured at the same position as the captured image can be selected as the comparison target image. By doing so, the image comparison unit 115 can compare images captured at the same position, making it possible to accurately detect an abnormality.

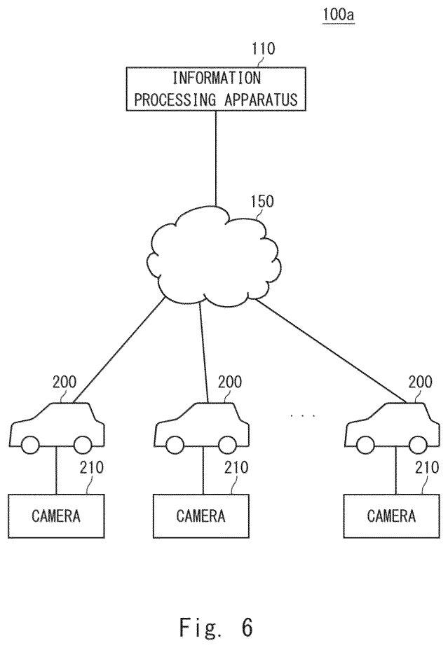

Next, a second example embodiment of the present disclosure will be described. FIG. 6 illustrates an information processing system according to the second example embodiment of the present disclosure. An information processing system 100a includes an information processing apparatus 110 and a plurality of cameras 210. In the information processing system 100a, each of the cameras 210 is mounted on a mobile object 200. The information processing apparatus 110 is connected to a mobile object 200 via a network 150. The network 150 includes, for example, a network using a communication line standard such as long term evolution (LTE). The network 150 may include a wireless communication network, such as WiFi (registered trademark) or a 5th generation mobile communication system.

The configuration of the information processing apparatus 110 according to the present example embodiment may be similar to the configuration of the information processing apparatus 110 described in the first example embodiment illustrated in FIG. 2. In the present example embodiment, the information processing apparatus 110 is configured as, for example, a server apparatus. In the present example embodiment, the image acquisition unit 111 acquires captured images from the cameras 210 of the plurality of mobile objects 200 via the network 150. The operation of the information processing apparatus 110 in the present example embodiment may be similar to the operation of the information processing apparatus 110 in the first example embodiment, except that captured images of the cameras 210 are collected from the plurality of mobile objects 200.

Note that the viewpoint position and the angle of view of the image of the camera 210 may be different for each of the mobile objects 200. In other words, the captured image of the camera 210 has an individual difference for each of the mobile objects 200. In the present example embodiment, when comparing images, the image comparison unit 115 may correct the viewpoint position and the angle of view for each of the captured image and the comparison target image to a predetermined reference viewpoint position and a predetermined reference angle of view. Alternatively, the image acquisition unit 111 may correct the viewpoint position and the angle of view of the captured image acquired from the camera 210 of each of the mobile objects 200 to a predetermined reference viewpoint position and a predetermined reference angle of view.

In the present example embodiment, the information processing apparatus 110 acquires captured images of the cameras 210 from the plurality of mobile objects 200. In this case, it is possible to increase the number of images used in detecting an abnormality as compared with that in a case where an abnormality is detected by comparing captured images of the camera 210 of one mobile object. Other effects are similar to those described in the first example embodiment.

Note that, in the first example embodiment, an example in which the information processing apparatus 110 is mounted on a mobile object has been described. However, the present disclosure is not limited thereto. In the first example embodiment, the information processing apparatus 110 is not necessarily mounted on a mobile object. For example, the information processing apparatus 110 and the camera 210 may be connected to each other via a network such as a wireless communication network, and the image acquisition unit 111 may acquire a captured image from the camera 210 via the network.

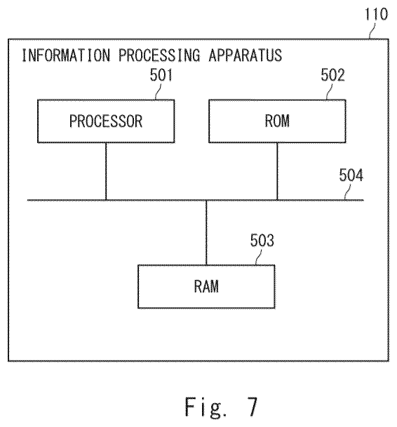

Next, a hardware configuration of the information processing apparatus 110 will be described. FIG. 7 illustrates a hardware configuration of the information processing apparatus 110. The information processing apparatus 110 includes a processor (central processing unit (CPU)) 501, a read only memory (ROM) 502, and a random access memory (RAM) 503. In the information processing apparatus 110, the processor 501, the ROM 502, and the RAM 503 are interconnected to each other via a bus 504. Although not illustrated, the information processing apparatus 110 may include other circuits such as a peripheral circuit, a communication circuit, and an interface circuit.

The ROM 502 is a non-volatile storage device. For example, a semiconductor storage device such as a flash memory having a relatively small capacity is used for the ROM 502. The ROM 502 stores a program executed by the processor 501.

The program described above includes a group of instructions (or software codes) for causing a computer to perform one or more of the functions described in the example embodiments when read by the computer. The program may be stored in a non-transitory computer-readable medium or a tangible storage medium. As an example and not by way of limitation, the computer-readable medium or the tangible storage medium includes a RAM, a ROM, a flash memory, a solid-state drive (SSD) or any other memory technology, a compact disc (CD), a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, the transitory computer-readable medium or the communication medium includes an electrical signal, an optical signal, an acoustic signal, or any other form of propagated signal.

The RAM 503 is a volatile storage device. As the RAM 503, various types of semiconductor memory devices such as a dynamic random access memory (DRAM) or a static random access memory (SRAM) can be used. The RAM 503 can be used as an internal buffer for transitorily storing data and the like.

The processor 501 loads the program stored in the ROM 502 on the RAM 503, and executes the program. The functions of the respective units in the information processing apparatus 110 can be realized by the CPU501 executing the program.

In each of the above-described example embodiments, it is not necessary that the information processing apparatus 110 be physically configured as one apparatus. In the present disclosure, the information processing apparatus 110 may be configured using a plurality of physically separated apparatuses. For example, in FIG. 2, the information processing apparatus 110 may be divided into an apparatus including the image acquisition unit 111, the class detection unit 112, the candidate extraction unit 113, the image selection unit 114, and the information accumulation unit 120, and an apparatus including the image comparison unit 115. Alternatively, the class detection unit 112, the candidate extraction unit 113, the image selection unit 114, and the image comparison unit 115 may be configured as independent apparatuses. The information processing apparatus 110 may be configured using an apparatus mounted on a mobile object and an apparatus installed at a location away from the mobile object.

Although the example embodiments of the present disclosure have been described above in detail, the present disclosure is not limited to the above-described example embodiments, and the present disclosure also includes changes or modifications made to the above-described example embodiments without departing from the gist of the present disclosure.

For example, some or all of the above-described example embodiments can be described as, but not limited to, the following supplementary notes.

### Supplementary Note 1

An information processing apparatus including:
a class detection means for analyzing a captured image captured by using a camera mounted on a mobile object, and classifying objects included in the captured image into a plurality of classes;
a candidate extraction means for extracting comparison target image candidates for comparison with the captured image from an information accumulation unit based on imaging information of the captured image, the information accumulation unit being configured to store one or more past images captured in the past, and imaging information including at least one of imaging date and time information and weather information at an imaging time for each of the one or more past images; and
an image selection means for selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

### Supplementary Note 2

The information processing apparatus according to supplementary note 1, in which the candidate extraction means extracts, as the comparison target image candidates, one or more of the past images of which the imaging information is similar to the imaging information of the captured image.

### Supplementary Note 3

The information processing apparatus according to supplementary note 1 or 2, in which the candidate extraction means extracts, as the comparison target image candidates, one or more of the past images of which the imaging information is similar to the imaging information of the captured image, and imaging position information is similar to imaging position information of the captured image.

### Supplementary Note 4

The information processing apparatus according to any one of supplementary notes 1 to 3, in which
the information accumulation unit further stores, for each of the past images, at least one of types of classes, sizes of regions of the respective classes, and proportions of the regions of the respective classes with respect to the entire image, and
the image selection means acquires, for each of the comparison target image candidates, at least one of types of classes, sizes of regions of the respective classes, and proportions of the regions of the respective classes with respect to the entire image, from the information accumulation unit.

### Supplementary Note 5

The information processing apparatus according to any one of supplementary notes 1 to 4, in which the class detection means stores, in the information accumulation unit, the captured image, the imaging information of the captured image, and at least one of types of the classes into which the objects are classified, sizes of regions of the respective classes, and proportions of the regions of the respective classes with respect to the entire image.

### Supplementary Note 6

The information processing apparatus according to any one of supplementary notes 1 to 5, in which the class detection means detects an object from the captured image, and classifies a region of the detected object into a class corresponding to the object.

### Supplementary Note 7

The information processing apparatus according to any one of supplementary notes 1 to 6, in which the class detection means divides the captured image into a plurality of regions according to classes to which the respective regions belong.

### Supplementary Note 8

The information processing apparatus according to any one of supplementary notes 1 to 7, in which the image selection means compares the types of the classes included in the captured image with the types of the classes included in each of the comparison target image candidates, and selects a past image in which the types of the classes match with those included in the captured image in the highest degree, as the comparison target image, from among the comparison target image candidates.

### Supplementary Note 9

The information processing apparatus according to any one of supplementary notes 1 to 8, in which the image selection means compares the sizes of the regions of the respective classes in the captured image with the sizes of the regions of the respective classes in each of the comparison target image candidates, and selects a past image in which the sizes of the regions of the respective classes match with those in the captured image in the highest degree, as the comparison target image, from among the comparison target image candidates.

### Supplementary Note 10

The information processing apparatus according to any one of supplementary notes 1 to 9, in which the image selection means compares the proportions of the regions of the respective classes with respect to the entire image in the captured image with the proportions of the regions of the respective classes with respect to the entire image in each of the comparison target image candidates, and selects a past image in which the proportions of the regions of the respective classes with respect to the entire image match with those in the captured image in the highest degree, as the comparison target image, from among the comparison target image candidates.

### Supplementary Note 11

The information processing apparatus according to any one of supplementary notes 1 to 10, further including a comparison means for comparing the captured image with the comparison target image selected by the image selection means.

### Supplementary Note 12

The information processing apparatus according to supplementary note 11, in which the comparison means calculates a difference between the captured image and the comparison target image.

### Supplementary Note 13

An information processing system including:
one or more cameras mounted on a mobile object; and
an information processing apparatus configured to perform image processing on a captured image captured by using the one or more cameras, in which
the information processing apparatus includes:
a class detection means for analyzing the captured image, and classifying objects included in the captured image into a plurality of classes;
a candidate extraction means for extracting comparison target image candidates for comparison with the captured image from an information accumulation unit based on imaging information of the captured image, the information accumulation unit being configured to store one or more past images captured in the past, and imaging information including at least one of imaging date and time information and weather information at an imaging time for each of the one or more past images; and
an image selection means for selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

### Supplementary Note 14

The information processing system according to supplementary note 13, in which the information processing apparatus acquires, from a plurality of mobile objects, a plurality of captured images captured by using cameras mounted on the respective mobile objects, via a network.

### Supplementary Note 15

The information processing system according to supplementary note 13 or 14, in which the candidate extraction means extracts, as the comparison target image candidates, one or more of the past images of which the imaging information is similar to the imaging information of the captured image.

### Supplementary Note 16

The information processing system according to any one of supplementary notes 13 to 15, in which the candidate extraction means extracts, as the comparison target image candidates, one or more of the past images of which the imaging information is similar to the imaging information of the captured image, and imaging position information is similar to imaging position information of the captured image.

### Supplementary Note 17

An information processing method including:
analyzing a captured image captured by using a camera mounted on a mobile object, and classifying objects included in the captured image into a plurality of classes;
extracting comparison target image candidates for comparison with the captured image from an information accumulation unit based on imaging information of the captured image, the information accumulation unit being configured to store one or more past images captured in the past, and imaging information including at least one of imaging date and time information and weather information at an imaging time for each of the one or more past images; and
selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

### Supplementary Note 18

A computer-readable medium storing a program for causing a computer to execute:
analyzing a captured image captured by using a camera mounted on a mobile object, and classifying objects included in the captured image into a plurality of classes;
extracting comparison target image candidates for comparison with the captured image from an information accumulation unit based on imaging information of the captured image, the information accumulation unit being configured to store one or more past images captured in the past, and imaging information including at least one of imaging date and time information and weather information at an imaging time for each of the one or more past images; and
selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

### REFERENCE SIGNS LIST

INFORMATION PROCESSING SYSTEM
20 INFORMATION PROCESSING APPARATUS
21 CLASS DETECTION MEANS
22 CANDIDATE EXTRACTION MEANS
23 IMAGE SELECTION MEANS
25 INFORMATION ACCUMULATION UNIT
30 CAMERA
100 INFORMATION PROCESSING SYSTEM
110 INFORMATION PROCESSING APPARATUS
111 IMAGE ACQUISITION UNIT
112 CLASS DETECTION UNIT
113 CANDIDATE EXTRACTION UNIT
114 IMAGE SELECTION UNIT
115 IMAGE COMPARISON UNIT
120 INFORMATION ACCUMULATION UNIT
150 NETWORK
200 MOBILE OBJECT
210 CAMERA
501 PROCESSOR
502 ROM
503 RAM
504 BUS

What is claimed is:

1. An information processing apparatus comprising:
at least one memory storing instructions; and
at least one processor configured to execute the instructions to:
analyze a captured image captured by using a camera mounted on a mobile object, and classify objects included in the captured image into a plurality of classes;
extract comparison target image candidates for comparison with the captured image from an information storage based on imaging information of the captured image, the information storage being configured to store one or more past images captured in the past, and imaging information including at least one of imaging date and time information and weather information at an imaging time for each of the one or more past images; and
select a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

2. The information processing apparatus according to claim 1, wherein the at least one processor is configured to execute the instructions to extract, as the comparison target image candidates, one or more of the past images of which the imaging information is similar to the imaging information of the captured image.

3. The information processing apparatus according to claim 1, wherein the at least one processor is configured to execute the instructions to extract, as the comparison target image candidates, one or more of the past images of which the imaging information is similar to the imaging information of the captured image, and imaging position information is similar to imaging position information of the captured image.

4. The information processing apparatus according to claim 1, wherein
the information storage further stores, for each of the past images, at least one of types of classes, sizes of regions of the respective classes, and proportions of the regions of the respective classes with respect to the entire image, and
the at least one processor is configured to execute the instructions to acquire, for each of the comparison target image candidates, at least one of types of classes, sizes of regions of the respective classes, and proportions of the regions of the respective classes with respect to the entire image, from the information storage.

5. The information processing apparatus according to claim 1, wherein the at least one processor is configured to execute the instructions to store, in the information storage unit, the captured image, the imaging information of the captured image, and at least one of types of the classes into which the objects are classified, sizes of regions of the respective classes, and proportions of the regions of the respective classes with respect to the entire image.

6. The information processing apparatus according to claim 1, wherein the at least one processor is configured to execute the instructions to detect an object from the captured image, and classify a region of the detected object into a class corresponding to the object.

7. The information processing apparatus according to claim 1, wherein the at least one processor is configured to execute the instructions to divide the captured image into a plurality of regions according to classes to which the respective regions belong.

8. The information processing apparatus according to claim 1, wherein the at least one processor is configured to execute the instructions to compare the types of the classes included in the captured image with the types of the classes included in each of the comparison target image candidates, and select a past image in which the types of the classes match with those included in the captured image in the highest degree, as the comparison target image, from among the comparison target image candidates.

9. The information processing apparatus according to claim 1, wherein the at least one processor is configured to execute the instructions to compare the sizes of the regions of the respective classes in the captured image with the sizes of the regions of the respective classes in each of the comparison target image candidates, and select a past image in which the sizes of the regions of the respective classes match with those in the captured image in the highest degree, as the comparison target image, from among the comparison target image candidates.

10. The information processing apparatus according to claim 1, wherein the at least one processor is configured to execute the instructions to compare the proportions of the regions of the respective classes with respect to the entire image in the captured image with the proportions of the regions of the respective classes with respect to the entire image in each of the comparison target image candidates, and select a past image in which the proportions of the regions of the respective classes with respect to the entire image match with those in the captured image in the highest degree, as the comparison target image, from among the comparison target image candidates.

11. The information processing apparatus according to claim 1, wherein the at least one processor is configured to execute the instructions to compare the captured image with the selected comparison target image.

12. The information processing apparatus according to claim 11, wherein the at least one processor is configured to execute the instructions to calculate a difference between the captured image and the selected comparison target image.

13. An information processing system comprising:
one or more cameras mounted on a mobile object; and
the information processing apparatus according to claim 1.

14. The information processing system according to claim 13, wherein the information processing apparatus acquires, from a plurality of mobile objects, a plurality of captured images captured by using cameras mounted on the respective mobile objects, via a network.

15. The information processing system according to claim 13, wherein the at least one processor is configured to execute the instructions to extract, as the comparison target image candidates, one or more of the past images of which the imaging information is similar to the imaging information of the captured image.

16. The information processing system according to claim 13, wherein the at least one processor is configured to execute the instructions to extract, as the comparison target image candidates, one or more of the past images of which the imaging information is similar to the imaging information of the captured image, and imaging position information is similar to imaging position information of the captured image.

17. An information processing method comprising:
analyzing a captured image captured by using a camera mounted on a mobile object, and classifying objects included in the captured image into a plurality of classes;
extracting comparison target image candidates for comparison with the captured image from an information storage based on imaging information of the captured image, the information storage being configured to store one or more past images captured in the past, and imaging information including at least one of imaging date and time information and weather information at an imaging time for each of the one or more past images; and
selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.

18. A non-transitory computer-readable medium storing a program for causing a computer to execute:
analyzing a captured image captured by using a camera mounted on a mobile object, and classifying objects included in the captured image into a plurality of classes;
extracting comparison target image candidates for comparison with the captured image from an information storage based on imaging information of the captured image, the information storage being configured to store one or more past images captured in the past, and imaging information including at least one of imaging date and time information and weather information at an imaging time for each of the one or more past images; and
selecting a comparison target image from among the comparison target image candidates based on at least one of types of the classes included in the captured image, sizes of regions of the respective classes, and proportions of the regions of the respective classes with respect to the entire image, and at least one of types of classes included in each of the comparison target image candidates, sizes of regions of the respective classes, and proportions of the regions of the respective classes with respect to the entire image.
